(19) United States
(12) Patent Application Publication
(10) Pub. No.: US 2021/0285411 A1
(43) Pub. Date: Sep. 16, 2021

(54) Fuel Injection Valve

(71) Applicant: Hitachi Automotive Systems, Ltd., Hitachinaka-shi, Ibaraki (JP)

(72) Inventors: Takaki ITAYA, Hitachinaka-shi (JP); Kenichiro OGATA, Hitachinaka-shi (JP); Masahiko INOUE, Hitachinaka-shi (JP); Masayuki SARUWATARI, Hitachinaka-shi (JP)

(21) Appl. No.: 16/321,656

(22) PCT Filed: Jul. 18, 2017
(86) PCT No.: PCT/JP2017/025847

§ 371 Date: Jan. 29, 2019

(30) Foreign Application Priority Data
Sep. 28, 2016 (JP) 2016-188987

(51) Int. Cl. F02M 61/18

(52) U.S. Cl. CPC F02M 61/1813; F02M 61/1833; F02M 61/1826

(57) ABSTRACT

An object is to provide a fuel injection valve that restricts attachment of fuel injected from an injection hole to a combustion chamber. A fuel injection valve including a plurality of injection holes on a front end section, each of the plurality of injection holes including an upstream hole formed on an upstream side and a downstream hole that is connected to the upstream hole, formed on a downstream side of the upstream hole, and has a diameter different from that of the upstream hole. A center axis of a first downstream hole is configured to be eccentric to a center axis side of the fuel injection valve relative to a center axis of a first upstream hole of a first injection hole. An eccentricity amount or an eccentricity direction of a downstream hole relative to an upstream hole of at least one of the other injection holes is different from an eccentricity amount or an eccentricity direction of the first injection hole.

### TECHNICAL FIELD

The present invention relates to a fuel injection valve.

### BACKGROUND ART

In a fuel injection valve mounted on an internal combustion engine that injects fuel directly into a combustion chamber, a fuel injection unit having a plurality of injection holes injects fuel in intended injection directions which are different between the injection holes. In this manner, a combustion state with excellent fuel efficiency, exhaust, and the like can be achieved.

In view of the above, PTL 1 discloses a structure of changing a penetration depending on an injection direction of fuel injected from a plurality of injection holes and a structure of the injection holes. PTL 1 discloses, in particular, a method of injection without colliding with a counterbore constituting a diffusion area on a downstream side on which fuel injected from an injection hole is injected from a guide area constituting the injection hole. The present invention discloses injection that does not cause spray to collide with an exit end portion by a configuration in which a center axis of a guide area is made eccentric to a far side relative to a center axis of a fuel injection valve PTL 2 discloses a technique of restricting attachment of fuel to a front end of a fuel injection valve depending on a passing angle of an injection hole.

### CITATION LIST

### Patent Literature

PTL 1: JP 2014-1660 A

PTL 2: JP 2015-135062 A

### SUMMARY OF INVENTION

### Technical Problem

In an internal combustion engine that inject fuel directly into a combustion chamber, fuel efficiency and exhaust may be deteriorated by fuel attached to a wall surface of the fuel chamber and an ignition plug, a piston, an intake valve, and the like, depending on a direction of orientation and an injection amount of each injection hole. While fuel is preferably injected with a short penetration in order to reduce fuel attached to a combustion chamber, an internal combustion engine that employs premixed ignition system as typified by a gasoline engine has a long penetration in order to expedite mixing. These requests are contradictory to each other. On the other hand, an amount of fuel attached to the inside of a combustion chamber is significantly different depending on an injection direction of fuel, and injecting fuel in a direction not causing attachment of fuel can also be considered. However, in view of expediting mixing as shown above, a direction of reducing attached fuel and an injection direction of fuel for expediting mixing do not match with each other.

PTL 1, JP 2014-1660 A, mentioned previously discloses restriction of attachment of fuel to an injection hole itself by making eccentric a counterbore constituting a diffusion area of an injection hole of a fuel injection valve. However, as to a method of restricting attachment of fuel to the inside of a combustion chamber after injection, attachment of fuel is determined depending on an injection direction determined by a guide area. Similarly, as to PTL 2, restriction of attachment of fuel injected from a fuel injection valve is determined depending on an injection direction.

When an injection hole (guide area in PTL 1) is made short in order to change a structure of an injection hole in an attempt to shorten a penetration in order to restrict an amount of fuel attached to the inside of a combustion chamber, a flow straightening distance is shortened, which causes an angle of a spray to spread more than intended, and the spray spreads widely in a radial direction with respect to a fuel injection valve.

In view of the above, an object of the present invention is to provide a fuel injection valve that restricts attachment of fuel injected from an injection hole to a combustion chamber.

### Solution to Problem

In order to achieve the above object, according to the present invention, there is provided a fuel injection valve including a plurality of injection holes on a front end section, each of the plurality of injection holes including an upstream hole formed on an upstream side and a downstream hole that is connected to the upstream hole, formed on a downstream side of the upstream hole, and has a diameter different from that of the upstream hole. A center axis of a first downstream hole is configured to be eccentric to a center axis side of the fuel injection valve relative to a center axis of a first upstream hole of a first injection hole. An eccentricity amount or an eccentricity direction of a downstream hole with respect to an upstream hole of at least one of the other injection holes is different from an eccentricity amount or an eccentricity direction of the first injection hole.

### Advantageous Effects of Invention

According to a fuel injection valve of the present invention, attachment to a combustion chamber of fuel injected from an injection hole can be restricted. An object, a configuration, and an advantageous effect other than those described above will be clarified in description of embodiments described below.

### BRIEF DESCRIPTION OF DRAWINGS

FIG. 1 is a configuration diagram of an engine system.

FIG. 2 is a configuration diagram of a fuel injection valve.

FIG. 3 is an injection configuration diagram of the inside of a combustion chamber.

FIG. 4 is a first configuration diagram of an injection hole of a fuel injection valve.

FIG. 5 is a second configuration diagram of an injection hole of a fuel injection valve.

FIG. 6 is a third configuration diagram of an injection hole of a fuel injection valve.

FIG. 7 is a relationship diagram of an injection hole of a fuel injection valve and a spray.

FIG. 8 is a configuration diagram of an injection hole of a fuel injection valve according to a second embodiment.

FIG. 9 is a configuration diagram of an injection hole of a fuel injection valve according to a third embodiment.

### DESCRIPTION OF EMBODIMENTS

Hereinafter, embodiments of a fuel injection valve according to the present invention will be described in detail with reference to the accompanying drawings.

### First Embodiment

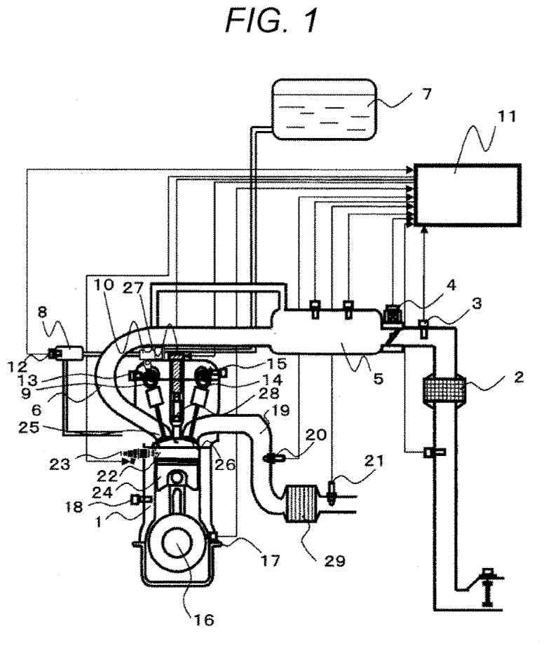

An embodiment of the present invention will be described with reference to the drawings. FIG. 1 shows a configuration example of an engine system to which the present embodiment is applied. The present embodiment assumes an engine of one cylinder or more, and the number of cylinders illustrated is one. First, basic operation of an engine 1 will be described. Air to be sucked in the engine 1 passes through an air cleaner before being sucked. An amount of the sucked air is measured by an air flow sensor (not shown) attached to an intake duct. An amount of air sucked in the engine 1 is controlled by a throttle valve 4. An intake collector 5 is used for distributing air to other cylinders (not shown). After that, air is distributed to an intake pipe of each cylinder, and air is sucked in a combustion chamber 22 through an intake valve 25. An air flow control valve (not shown) that provides directivity to an air flow may be used in an intake pipe 6. As a path of fuel, fuel from a fuel tank 7 that is pressurized by projection of a low-pressure fuel pump (not shown) in a fuel pipe is transported to a common rail 8. Along with the above, fuel is further accumulated and pressurized in a high-pressure fuel pump 10 attached to an intake cam shaft 9.

An engine control unit (hereinafter referred to as ECU) 11 determines an operating situation of the engine 1 in the inside of the ECU 11 based on a signal from a variety of sensors attached to the engine 1, and outputs an instruction value corresponding to the operating situation to a variety of actuators. Examples of the variety of sensors include the air flow sensor 3, a fuel pressure sensor 12 that detects a pressure of fuel set to the common rail 8, a phase sensor 13 that detects a phase of the intake cam shaft 9, a phase sensor 15 that detects a phase of an exhaust cam 14, a crank angle sensor 17 that detects the number of rotations of a crank shaft 16, a water temperature sensor 18 that detects a temperature of engine cooling water, a knock sensor (not shown) that detects knocking, and exhaust gas sensors (an exhaust A/F sensor 20 and exhaust O2 sensor 21) that detect a concentration of exhaust gas in an exhaust pipe 19. Examples of the variety of actuators include a fuel injection valve 23, the high-pressure fuel pump 10, the throttle valve 4, an air flow control valve (not shown), a phase control valve (not shown) that controls intake and exhaust cam phases, and an ignition coil 27 or an ignition plug 28.

In operation and configuration of the engine 1, a control unit (microcomputer) of the ECU 11 calculates a fuel injection amount of the fuel injection valve 23 by taking in an air amount measured by the air flow sensor 3 and signals from the exhaust A/F sensor 20 and the exhaust O2 sensor 21. The control unit (microcomputer) of the ECU 11 also detects a fuel pressure of fuel pressurized by the high-pressure fuel pump 10 by using the fuel pressure sensor 12, and determines an injection period (injection pulse width) of the fuel injection valve 23 based on the calculated fuel injection amount of the fuel injection valve and the detected fuel pressure. As the ECU 11 sends an injection pulse signal to a drive circuit of the fuel injection valve 23 (not shown), and the drive circuit of the fuel injection valve 23 outputs a drive current to the fuel injection valve 23, fuel is injected.

A drive signal sent from the ECU 11 is mainly constituted by an injection timing, the number of times of injection, and an injection period. Air and fuel supplied to the combustion chamber 22 are vaporized and mixed in the combustion chamber 22 along with vertical movement of a piston 24, so that a fuel-air mixture is formed. After that, a temperature and a pressure are increased by compression movement of the piston 24. The ECU 11 calculates an ignition timing based on information of an engine speed, a fuel injection amount, and the like, and outputs an ignition signal to the ignition coil 27. The ignition signal is mainly constituted by an electrification start timing and an electrification end timing for the ignition coil 27.

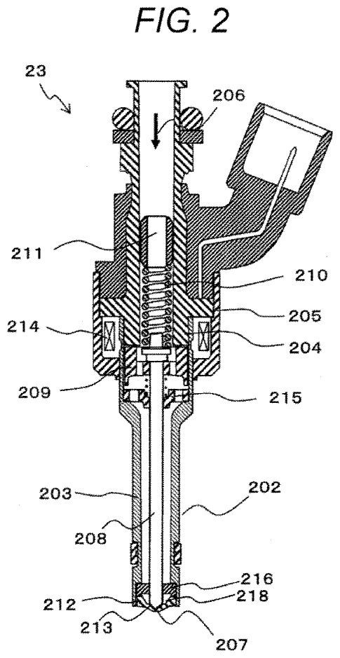

In this manner, ignition is performed by the ignition plug 28 at a timing slightly before a compression top dead center of the piston 24, and a fuel-air mixture in the combustion chamber is ignited and combustion occurs. A timing of ignition is different depending on an operation state, and may be after a compression top dead center. By a pressure increased by combustion, a force of pushing back in a downward direction acts on the piston 24, and is transmitted to the crank shaft 16 as an engine torque in an expansion process to become engine power. After combustion ends, gas that remains in the combustion chamber 22 passes through an exhaust valve 26 and is discharged to the exhaust pipe 19. This exhaust gas, which usually contains a component that is harmful to a human body, is detoxified by an action of a catalyst 29 disposed in the exhaust pipe 19, and is discharged to the air. Next, a detailed configuration of the fuel injection valve 23 of the present embodiment will be described with reference to FIG. 2. The fuel injection valve used in the description of FIG. 2 is an example, and the present invention is not limited to the present configuration. In the fuel injection valve 23 shown in FIG. 2, a valve main body 202 includes a nozzle holder 203, a core 204, and a housing 205.

Fuel from the high-pressure fuel pump 10 in FIG. 1 passes through a plurality of fuel injection holes 207 via a fuel path 206 before being discharged. A valve element 208 is contained in the nozzle holder 203 in an axially slidable manner with an anchor 209 provided between them. A spring 210 is disposed between the valve element 208 and an adjuster pin 211. The adjuster pin 211 restrains a position of an upper end portion of the spring 210. With the spring 210 pressing the valve element 208 against a seat section 213 of a seat member 212, a fuel injection hole 207 is closed. The seat section 213 with which the valve element 208 is in contact in a valve closed state is formed on the seat member 212, and a plurality of the fuel injection holes 207 are formed on a downstream side of the seat section 213. The present embodiment employs the configuration where a plurality of the fuel injection holes 207 is formed on the seat member 212 together with the seat section 213. However, the present invention is not limited to this configuration, and a plurality of the fuel injection holes 207 may be formed on a member separate from the seat member 212.

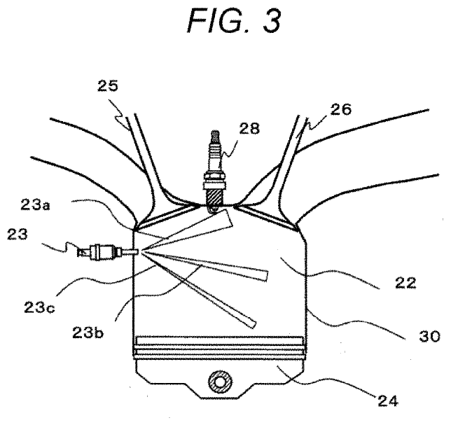

A solenoid 214 is disposed above the anchor 209. Upon receiving a drive current from the drive circuit 11 in FIG. 1, the solenoid 214 is electrified. This electrification excites the core 204 to generate a magnetic attraction force that axially pulls up the anchor 209. Along with the above, the valve element 208 is axially pulled up by the anchor 209. At this time, the valve element 208 moves away from the seat section 213, and guides 215 and 216 guide the valve element 208 in a sliding direction. In this manner, a plurality of the fuel injection holes 207 become in an open valve state. Accordingly, fuel that is pressurized and press-fed by the high-pressure fuel pump 10 in FIG. 1 passes through the fuel path 206, and is injected into the combustion chamber 22 through a plurality of the fuel injection holes 207. Next, a behavior of fuel that is injected into a combustion chamber and a behavior of generation of attachment of fuel will be described in detail with reference to FIG. 3. Fuel is injected into the combustion chamber 22 in directions shown by sprays 23a, 23b, and 23c from each injection hole of the fuel injection valve 23. The spray 23a is injected toward a front end portion of the ignition plug 28 most closely as compared with the other sprays. The spray 23b is injected toward the front end portion of the ignition plug 28 closely next to the spray 23a, and is also injected toward a combustion chamber wall surface 30. The spray 23a is injected on an upper side and the spray 23b is injected on a lower side along a horizontal direction of the combustion chamber 22. The spray 23c is injected to an even lower side than the spray 23b along the horizontal direction of the combustion chamber 22, and is most oriented to the piston 24 as compared with the other sprays.

The spray 23b and the spray 23c, which are displayed as one spray for simpler description in FIG. 3, are preferably constituted by sprays injected from two or more injection holes. A timing of injection from the fuel injection valve 23 varies depending on whether ignition is performed after a state in a combustion chamber is a homogeneous mixture, or stratified charge combustion in which a fuel-air mixture is gathered around the ignition plug 28 and ignited in layers for combustion is performed. In the present embodiment, an injection mode in which fuel is mixed homogeneously in the combustion chamber and ignited will be employed for description.

In an intake process of an engine, mixing is expedited in a combustion chamber and a homogeneous fuel-air mixture is ignited during a period from suction of air to injection and ignition of fuel. At this time, when a sufficient time period can be obtained for vaporization of fuel and mixing of air and fuel before ignition, injection from the fuel injection valve 23 can be delayed, and injection can be performed at an appropriate timing corresponding to an air flow in a combustion chamber without limitation to injection during an intake process. At this time, a pressure of injected fuel is preferably increased to 10 MPa or higher for atomization and adjustment of a penetration.

When the above injection is executed, fuel that is diffused in the combustion chamber sometimes reaches the intake valve 25, the piston 24, and the combustion chamber wall surface 30. In such a case, the fuel is attached to them. In contrast, if a penetration of fuel injection can be shortened, attached fuel can be reduced. However, the penetration that is too short causes deterioration in mixing in view of promotion of mixing. Accordingly, a change is preferably made by an air flow in a combustion chamber that is changed by a shape of the combustion chamber 22, for example, a bore and a stroke, the throttle valve 4, an open valve amount of the intake valve 25, a tumble control valve and the like attached in an intake port (not shown), and the like.

The spray 23a is injected most closely to the ignition plug 28. In view of the above, in the present embodiment, the spray is injected without being spread in an ignition plug direction by employing a structure of an injection hole described later. The spray 23b injected at the same time is not spread in a direction of the combustion chamber wall surface 30 by employing a structure of an injection hole described later. An injection hole structure described later is employed also for the spray 23c injected in a piston direction, so that spread in a piston direction is restricted.

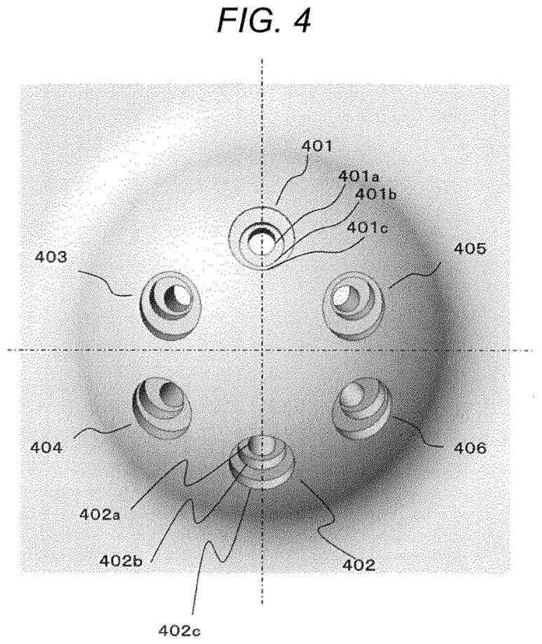

Next, the fuel injection valve 23 in FIG. 2 and a member constituting a plurality of injection holes of the fuel injection valve 23 in FIG. 3 will be described with reference to FIGS. 4, 5, and 6. FIG. 4 shows a plurality of injection holes 401, 402, 403, 404, 405, and 406. For convenience of description, six injection holes are shown. However, the present invention is not limited to them. In view of a spray oriented to the vicinity of an ignition plug and a configuration of injecting into a combustion chamber, five or more holes are preferably included. Next, the injection hole 401 will be described. The injection hole 401 is used for injecting the spray 23a that is closest to an ignition plug.

A plurality of injection holes (401, 402, 403, 404, 405, and 406) are formed on a front end portion (seat member). A plurality of the injection holes (401, 402, 403, 404, 405, and 406) respectively include upstream holes (401a, 402a, 403a, 404a, 405a, and 406a) formed on an upstream side and downstream holes (401b, 402b, 403b, 404b, 405b, and 406b) that are connected to the upstream holes and formed on a downstream side of the upstream holes, and have a diameter different from that of the upstream holes (401a, 402a, 403a, 404a, 405a, and 406a). In FIG. 4, the upstream holes (401a and 402a), the downstream holes (401b and 402b), and different-diameter downstream holes (401c and 402c) on a farther downstream side are shown only for the first injection hole 401 and the second injection hole 402, and reference signs are omitted for the other injection holes.

In the present embodiment, a center axis of the first downstream hole 401b is made eccentric to a center axis side of the fuel injection valve 23 relative to a center axis of the first upstream hole 401a of the first injection hole 401. In the present embodiment, a center axis of the fuel injection valve 23 and a center axis of the valve element 208 are on the same axis. A plurality of the injection holes (401, 402, 403, 404, 405, and 406) are configured in a manner that an eccentricity amount or an eccentricity direction of a downstream hole with respect to an upstream hole of at least one of the other injection holes (402, 403, 404, 405, and 406) is different from an eccentricity amount or an eccentricity direction of the first injection hole 401. In this manner, for an internal combustion engine of a side injection type, the first injection hole 401 is disposed to be most oriented to a front end portion of the ignition plug 28 as compared with the other injection holes, which restricts spread of a spray to the ignition plug 28 side.

In the present embodiment, among a plurality of the injection holes (401, 402, 403, 404, 405, and 406), a center axis of the first upstream hole 401a of the first injection hole 401 is configured to have a smallest angle with respect to a center axis of the fuel injection valve 23. The first downstream hole 401b of the first injection hole is disposed to be eccentric to a valve element center axis direction relative to the first upstream hole 401a. Accordingly, a thickness between a counterbore section forming the first downstream hole 401b and a portion constituting a fuel path on an inner side tends to be thin. For this reason, an eccentricity amount is preferably small. When a certain thickness can be secured, an amount of eccentricity may be changed depending on a shape of a combustion chamber, a projecting amount of an ignition plug, arrangement of fuel injected from a plurality of injection holes, and the like.

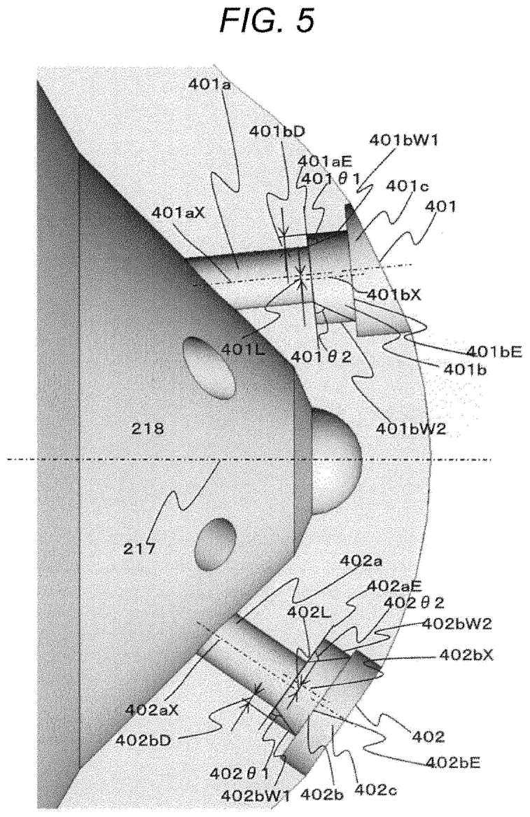

The above point will be described in detail with reference to a cross section of FIG. 5. FIG. 5 is a cross-sectional view of a plane that passes through a center axis of the first injection hole 401, a center axis 217 of the fuel injection valve 23, and a center axis of the second injection hole 402.

First, the injection hole 401 that injects fuel to the vicinity of a front end portion of the ignition plug 28 will be described. The injection hole 401 passes through a fuel path 218, and then passes through the first upstream hole 401a on an upstream side to the first downstream hole 401b. At this time, the first upstream hole 401a plays a role of adjusting an injection direction and an injection amount by a channel resistance when fuel passes through the injection hole.

Next, when fuel flows out from the first upstream hole 401a to the first downstream hole 401b, a spray is diffused in accordance with a flow rate in a radial direction of the fuel injection valve. In the present embodiment, a center axis 401bx of the first downstream hole 401b is eccentric to the side of the center axis 217 of the fuel injection valve 23 relative to a center axis 401ax of the first upstream hole 401a. Due to this eccentricity, space on the side of an external diameter side wall 401bW1 of the first downstream hole 401b is narrow, which causes a spray to hit the external diameter side wall 401bW1. In this manner, spreading of a spray is restricted beyond the external diameter side wall 401bW1. At this time, space on the side of the internal diameter side wall 401bW2 in an eccentric direction is widened in contrast, and a spray from the first upstream hole 401a is diffused and spreads without hitting the internal diameter side wall 401bW2.

That is, in the present embodiment, the first upstream hole 401a and the first downstream hole 401b of the first injection hole 401 are configured so that fuel from the first upstream hole 401a hits a side wall on an external diameter side on an exit surface of the first downstream hole 401b.

Accordingly, beyond the external diameter side wall 401bW1 of the first downstream hole 401b, a spray does not spread on an external diameter side. On the other hand, beyond the internal diameter side wall 401bW2 of the first downstream hole 401b, the spray has a spray shape that spreads and is diffused on an internal diameter side.

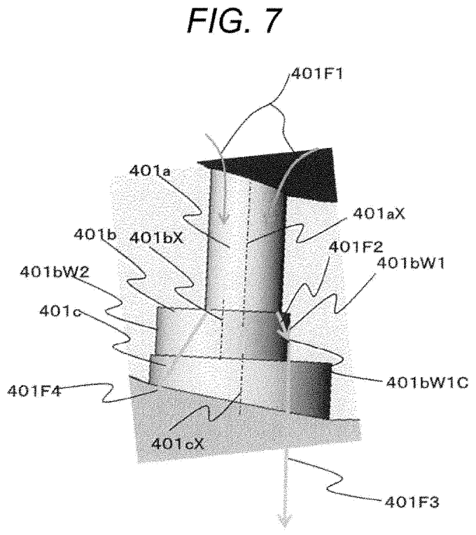

In a plurality of the injection holes (401, 402, 403, 404, 405, and 406), different-diameter downstream holes (401c, 402c, 403c, 404c, 405c, and 406c) having a different diameter are respectively formed on a further downstream side of the downstream holes (401b, 402b, 403b, 404b, 405b, and 406b), and the different-diameter downstream holes (401c, 402c, 403c, 404c, 405c, and 406c) have an injection hole length shorter than that of the downstream holes. Each injection hole length is defined by a length between an entrance surface center and an exit surface center. In this manner, an injection hole with which a spray hardly collides can be obtained. The spray shape at the time of injection will be described with reference to FIG. 7 later.

Next, an eccentricity amount 401L of the first downstream hole 401b with respect to the first upstream hole 401a will be described. The eccentricity amount 401L is set so as to cause a spray injected from the first upstream hole 401a to collide with the external diameter side wall 401bW1. At this time, the spray is set not to spread by a position of the ignition plug 28, a shape of the combustion chamber 22, and the like as described in FIG. 4.

A plurality of the injection holes (401, 402, 403, 404, 405, and 406) are formed on a front end portion (seat member) of the fuel injection valve 23 of the present embodiment. The plurality of injection holes respectively includes upstream holes (401a, 402a, 403a, 404a, 405a, and 406a) formed on an upstream side and downstream holes (401b, 402b, 403b, 404b, 405b, and 406b) that are connected to the upstream holes and formed on a downstream side of the upstream holes.

In FIG. 5, an angle 40101 is defined as an angle formed by a tangent drawn parallel to an exit surface 401aE of the first upstream hole 401a and a straight line connecting an external diameter side exit end portion on the exit surface 401aE of the first upstream hole 401a and an external diameter side exit end portion on an exit surface 401bE of the first downstream hole 401b. An angle 40102 is defined as an angle formed by a tangent drawn parallel to the exit surface 401aE of the first upstream hole 401a and a straight line connecting an internal diameter side exit end portion on the exit surface 401aE of the first upstream hole 401a and an internal diameter side exit end portion on the exit surface 401bE of the first downstream hole 401b. In the present embodiment, the first injection hole is configured so that the angle 40102 on an internal diameter side is smaller than the angle 40101 on an external diameter side.

In FIG. 5, an angle 40201 is defined as an angle formed by a tangent drawn parallel to an exit surface 402aE of the second upstream hole 402a and a straight line connecting an external diameter side exit end portion on the exit surface 402aE of the second upstream hole 402a and an external diameter side exit end portion on an exit surface 402bE of the second downstream hole 402b. An angle 40202 is defined as an angle formed by a tangent drawn parallel to the exit surface 402aE of the second upstream hole 402a and a straight line connecting an internal diameter side exit end portion on the exit surface 402aE of the second upstream hole 402a and an internal diameter side exit end portion on the exit surface 402bE of the second downstream hole 402b. In the present embodiment, the first injection hole is configured so that the angle 40202 on an internal diameter side is smaller than the angle 40201 on an external diameter side.

The third injection hole 403 formed adjacent to the first injection hole 401 in a circumferential direction is configured so that an angle 40302 formed by a tangent drawn parallel to an exit surface 403aE of the third upstream hole 403a and a straight line connecting an internal diameter side exit end portion on the exit surface 403aE of the third upstream hole 403a and an internal diameter side exit end portion on an exit surface 403bE of the third downstream hole 403b is larger than an angle 40301 formed by a tangent drawn parallel to the exit surface 403aE of the third upstream hole 403a and a straight line connecting an external diameter side exit end portion on the exit surface 403aE of the third upstream hole 403a and an external diameter side exit end portion on the exit surface 403bE of the third downstream hole 403b.

In a state where the fuel injection valve 23 is attached to an internal combustion engine, the first injection hole 401 is disposed to be oriented most to a front end portion of the ignition plug 28, and the second injection hole 402 is disposed to be oriented most to an upper surface center portion of the piston 24 among a plurality of injection holes.

In the present embodiment, the first injection hole 401 is configured so that the angle θ1 formed by a tangent 401aE drawn parallel to the exit surface of the first upstream hole 401a and a straight line connecting an external diameter side exit end portion on the exit surface of the first upstream hole 401a and an external diameter side exit end portion on the exit surface of the first downstream hole 401b is 45 deg. or larger. An angle of a spray injected from the first upstream hole 401a depends on a length and a diameter of the first upstream hole 401a. For this reason, in accordance with it, a distance 401bD from an external diameter side exit end portion on an exit surface of the first upstream hole 401a or an external diameter side wall of the first upstream hole 401a to an external diameter side wall 401bW1 of the first downstream hole 401b is set. The eccentricity amount 401L and a hole diameter of the first downstream hole 401b are preferably set in consideration of a thickness between the fuel path 218 before a plurality of injection holes and the first downstream hole 401b.

Next, the second injection hole 402 that is oriented most to the vicinity of an upper surface center portion of the piston or the upper surface center portion of the piston 24 as compared with other injection holes will be described.

Among a plurality of the injection holes (401, 402, 403, 404, 405, and 406), the second injection hole 402 is positioned on an end portion on an opposite side of the first injection hole 401 with respect to the center axis 217 of the fuel injection valve 23. The second injection hole 402 includes the second upstream hole 402a formed on an upstream side and the second downstream hole 402b that is connected to the second upstream hole 402a and formed on a downstream side of the second upstream hole 402a. Like the first injection hole 401, fuel passes through the fuel path 218, and then passes through the second upstream hole 402a on an upstream side, and flows out to the second downstream hole 402b on a downstream side. The second downstream hole 402b is eccentric to the side of the center axis 217 of the fuel injection valve 23, that is, to an internal diameter side, relative to the second upstream hole 402a. In this manner, a spray from the second upstream hole 402a can be configured to collide with an external diameter side wall 402bW1 of the second downstream hole 402b. Accordingly, spread of a spray to the side of an upper surface center portion of the piston 24 can be restricted. Since the injection hole is spread to an internal diameter side by eccentricity, a spray of the second downstream hole 402b hardly collides with the side wall 30 of the combustion chamber 22. In this manner, attachment of fuel to the side wall 30 can be restricted. A shape of the spray of the injection hole 402 will be described later with reference to FIG. 7.

A center axis 402bX of the second downstream hole 402b is eccentric to an internal diameter side (the center axis 217 side of the fuel injection valve 23) relative to a center axis 402aX of the second upstream hole 402a. This eccentricity amount 402L is preferably set to be larger than the eccentricity amount 401L of the injection hole 401.

A position and an amount of attachment of fuel injected from a fuel injection valve vary depending on a distance from a front end of the fuel injection valve to a combustion chamber wall surface and a position of a piston determined by an injection timing. Accordingly, an eccentricity amount is preferably changed in accordance with a shape of the combustion chamber 22 and a position of the piston 24 determined by an injection timing. In the present embodiment, a distance 402bD from an external diameter side exit end portion on an exit surface of the second upstream hole 402a or an external diameter side wall of the second upstream hole 402a to the external diameter side wall 402bW1 of the second downstream hole 402b is smaller than the distance 401bD described above.

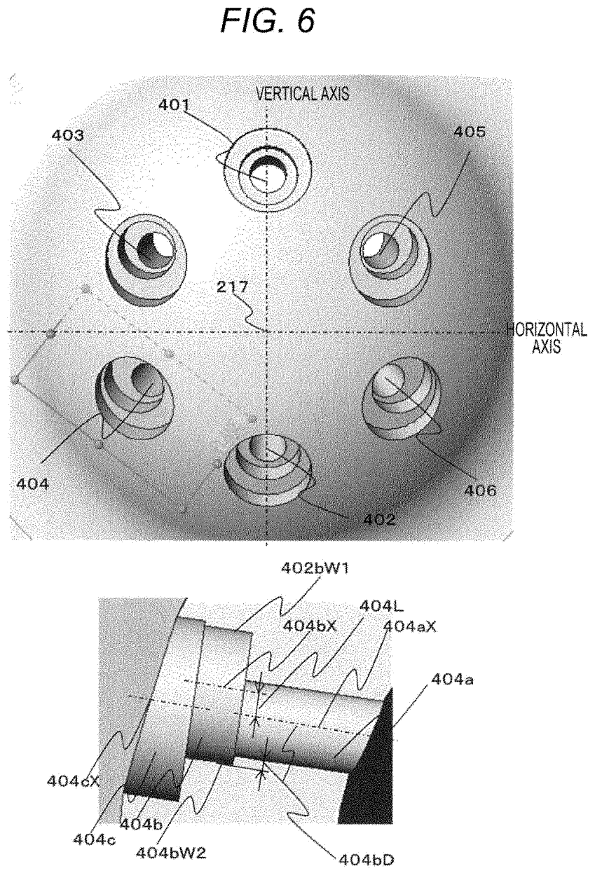

Next, injection holes other than the first injection hole 401 and the second injection hole 402 in FIG. 4 will be described with reference to FIG. 6. With the center axis 217 of the fuel injection valve 23 at the center, a straight line passing through the center axis 217 and an exit surface center of the first different-diameter downstream hole 401c of the first injection hole is shown as a vertical axis. A straight line perpendicular to the vertical axis is shown as a horizontal axis. In the present embodiment, the number of injection holes oriented most to a front end portion of the ignition plug 28 is one, the first injection hole 401. When two of the injection holes are formed in parallel, the vertical axis is drawn to pass through an exact middle of a straight line connecting exit surface centers of these injection holes.

Among a plurality of the injection holes (401, 402, 403, 404, 405, and 406), the third injection hole 403 is formed adjacent to the first injection hole 401 in a circumferential direction. Like the first injection hole 401 and the second injection hole 402, the third injection hole 403 includes the third upstream hole 403a formed on an upstream side and the third downstream hole 403b that is connected to the third upstream hole 403a and formed on a downstream side of the third upstream hole 403a.

A center axis 403bX of the third downstream hole 403b is configured to be at a position eccentric to the side away from the center axis 217 of the fuel injection valve 23 relative to a center axis 403aX of the third upstream hole 403a. The center axis 403bX of the third downstream hole 403b may be away from the vertical axis and the horizontal axis. In this manner, interference with a spray from the first injection hole 401 by a spray from the third injection hole 403 can be restricted.

An upper diagram of FIG. 6 shows arrangement of injection holes like FIG. 4. A lower diagram of FIG. 6 shows a direction in which the fourth injection hole 404 is eccentric the most and a cross section of a plane that passes through the fourth upstream hole 404a of the fourth injection hole 404. In the fourth injection hole 404, fuel that flows out after passing through the fourth upstream hole 404a flows out to the fourth downstream hole 404b on a downstream side having a center axis 404bX.

Among a plurality of the injection holes (401, 402, 403, 404, 405, and 406), the fourth injection hole 404 is formed adjacent to the third injection hole 403 in a circumferential direction. The fourth injection hole 404 includes the fourth upstream hole 404a formed on an upstream side and the fourth downstream hole 404b that is connected to the fourth upstream hole 404a and formed on a downstream side of the fourth upstream hole 404a. The center axis 404bX of the fourth downstream hole 404b is configured to be at a position eccentric to the side away from the center axis 217 of the fuel injection valve 23 relative to a center axis 404aX of the fourth upstream hole 404a.

The center axis 404bX of the fourth downstream hole 404b is configured to be away from the vertical axis and close to the horizontal axis. In this manner, interference with sprays from the second injection hole 402 and the third injection hole 403 by a spray from the fourth injection hole 404 can be restricted.

In the fourth injection hole 404, due to the above eccentricity, space on the side of an internal diameter side wall 404bW2 of the fourth downstream hole 404b is narrow, which causes a spray to collide with the internal diameter side wall 404bW2. In this manner, spread of a spray is restricted beyond the internal diameter side wall 404bW2. At this time, space on the side of an external diameter side wall 404bW1 in an eccentricity direction is widened in contrast, and a spray from the fourth upstream hole 404a is diffused and spreads without colliding with the external diameter side wall 404bW1.

As described above, the first injection hole 401 and the second injection hole 402 are eccentric to a center side (the horizontal axis side) of the fuel injection valve 23 so that attachment of fuel to the inside of the combustion chamber 22, such as the ignition plug 28 and the piston 24, is restricted. In this manner, sprays from the first injection hole 401 and the second injection hole 402 are easily diffused to the center side (the horizontal axis side).

On the other hand, since the third injection hole 403 and the fourth injection hole 404 have the above configurations, an interference between sprays injected from injection holes adjacent with each other can be avoided, and attachment of fuel to the wall surface 30 of the combustion chamber 22 can also be avoided.

Due to varied distances to a combustion chamber wall surface after injection, an eccentricity amount 404L at the fourth injection hole 404 is not the same as the eccentricity amount 401L at the first injection hole 401 or the eccentricity amount 402L at the second injection hole 402. In the present embodiment, since there is space on an external diameter side in the fourth injection hole 404, the eccentricity amount 404L is configured to be larger than the eccentricity amount 401L and the eccentricity amount 402L.

The eccentricity amount 404L is determined by an angle at which a spray is caused to collide with the internal diameter side wall 404bW2 of the fourth downstream hole 404c. Accordingly, a distance 404bD from an internal diameter side exit end portion on an exit surface of the fourth upstream hole 404a or an internal diameter side wall of the fourth upstream hole 404a to the internal diameter side wall 404bW2 of the fourth downstream hole 404b is smaller than the distance 401bD of the first injection hole 401 and the distance 402bD of the second injection hole 402.

Next, description will be made on a direction in which fuel injected from an injection hole of a fuel injection valve collides with a wall surface of the injection hole and spread of the fuel is restricted, and a direction in which such spread of the fuel is not restricted with reference to FIG. 7. FIG. 7 shows a cross section showing the eccentricity of the first injection hole 401 described previously. A flow 401F1 of fuel flowing into the first injection hole 401 is shown to flow into the first upstream hole 401a having a center axis 702a. Next, when a spray flows into the first downstream hole 401b having the center axis 401bX, a spray that spreads in a direction of a spray flow 401F2 collides, at a collision portion 703d, with the external diameter side wall 401bW1 of the first downstream hole 401b on a downstream side that is made eccentric. After that, the spray flow is guided to a direction 401F3.

On the other hand, an amount of a spray, which spreads in a direction of a spray flow 401F4, that collides with the internal diameter side wall 401bW2 can be restricted, since the center axis 401bX of the first downstream hole 401b is made eccentric. Accordingly, a spray from the first injection hole 401 has a spray shape that spreads on an internal diameter side.

Due to the above spread of the spray, the spray that collides with the external diameter side wall 401bW1 is guided and a penetration is easily extended. A spray that does not collides with the internal diameter side wall 401bW2 or is on the eccentric side for less collision spreads in an internal diameter direction, and a penetration becomes short.

According to the fuel injection valve of the present embodiment described above, an amount of fuel attached to the combustion chamber 22, the ignition plug 28, and the piston 24 at the time the fuel is injected can be reduced, and an internal combustion engine with improved fuel efficiency and exhaust performance can be obtained.

### Second Embodiment

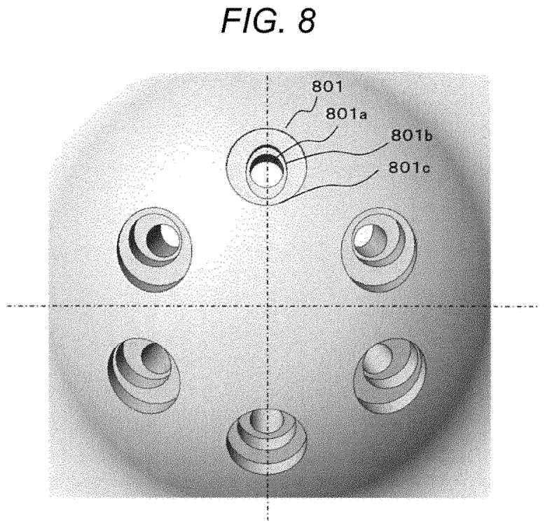

A second embodiment of the present invention will be described with reference to FIG. 8. In the structure of an injection hole according to the first embodiment, at least one injection hole may be formed in an elliptic shape as shown in FIG. 8. Since a downstream hole 801b having an elliptic shape is formed in an eccentric manner with respect to an upstream hole 801a, a spray from the upstream hole 801a collides with a side surface of the downstream hole 801b, like the first embodiment. Accordingly, spread of the spray on the side surface side can be restricted. A most downstream hole 801c on a further downstream of the downstream hole 801b is preferably configured not to restrict spread of fuel that has passed through the downstream hole 801b.

In the present embodiment, the upstream hole 801a and the most downstream hole 801c have a circular shape. However, each of the upstream hole 801a and the most downstream hole 801c may be formed in an elliptic shape. Alternatively, even when either one of them is formed in a circular shape and the other one in an elliptic shape, an advantageous effect similar to that of the first embodiment can be obtained.

### Third Embodiment

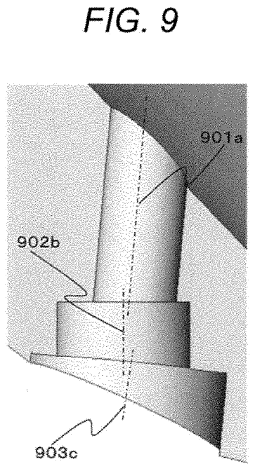

A third embodiment of the present invention will be described with reference to FIG. 9. In the injection hole according to the first embodiment, the configuration may be such that center axes of an upstream hole 901a, a downstream hole 901b, and a most downstream hole 901c are not coaxial as shown in FIG. 9. In the present embodiment, a center axis of the downstream hole 901b is inclined toward a wall surface on a colliding side relative to a center axis of the upstream hole 901a. The downstream hole 901b may also be made eccentric so that an intersection of a center axis of the downstream hole 901b and an exit surface of the upstream hole 901a is on an opposite side (on the left in FIG. 9) to a colliding side with respect to a center axis of the upstream hole 901a.

In this manner, an advantageous effect similar to that of the first embodiment can be obtained.

### REFERENCE SIGNS LIST

11 Engine control unit (ECU)
12 Fuel pressure sensor
23 Fuel injection valve
23a Spray injected most closely to ignition plug
23b Spray in combustion chamber wall surface direction
23c Spray injected most closely to piston
28 Ignition plug
202 Valve main body
204 Core
207 Plurality of fuel injection holes
208 Valve element
209 Anchor
210 Spring
212 Seat member
213 Seat section
214 Solenoid
401 Injection hole that injects spray closest to ignition plug
401a Upstream side injection hole constituting injection hole 401
401b Downstream side injection hole constituting injection hole 401
401c Most downstream side injection hole constituting injection hole 401

1. A fuel injection valve comprising a plurality of injection holes on a front end section, each of the plurality of injection holes including an upstream hole formed on an upstream side and a downstream hole that is connected to the upstream hole, formed on a downstream side of the upstream hole, and has a diameter different from that of the upstream hole, wherein
a center axis of a first downstream hole is configured to be eccentric to a center axis side of the fuel injection valve relative to a center axis of a first upstream hole of a first injection hole, and
an eccentricity amount or an eccentricity direction of a downstream hole with respect to an upstream hole of at least one of the other injection holes is different from an eccentricity amount or an eccentricity direction of the first injection hole.

2. The fuel injection valve according to claim 1, wherein
the first upstream hole and the first downstream hole of the first injection hole are configured so that fuel from the first upstream hole collides with a side wall on an external diameter side on an exit surface of the first downstream hole.

3. The fuel injection valve according to claim 1, wherein
each of the plurality of injection holes includes a different-diameter downstream hole having a different diameter formed on a further downstream side of the downstream hole, and
the different-diameter downstream hole is formed to have an injection length shorter than that of the downstream hole.

4. The fuel injection valve according to claim 1, wherein
among the plurality of injection holes, the center axis of the first upstream hole of the first injection hole is configured to have a smallest angle with respect to a center axis of the fuel injection valve.

5. The fuel injection valve according to claim 4, wherein
among the plurality of injection holes, a second injection hole positioned in an end portion on an opposite side of the first injection hole with respect to the center axis of the fuel injection valve includes a second upstream hole formed on an upstream side and a second downstream hole that is connected to the second upstream hole and formed on a downstream side of the second upstream hole, and
a center axis of the second downstream hole is at a position eccentric to a center axis side of the fuel injection valve relative to a center axis of the second upstream hole.

6. The fuel injection valve according to claim 4, wherein
among the injection holes, a third injection hole formed adjacent to the first injection hole in a circumferential direction includes a third upstream hole formed on an upstream side and a third downstream hole that is connected to the third upstream hole and formed on a downstream side of the third upstream hole, and
a center axis of the third downstream hole is at a position eccentric to a side away from a center axis side of the fuel injection valve relative to a center axis of the third upstream hole.

7. The fuel injection valve according to claim 1, wherein
an angle formed by a tangent drawn parallel to an exit surface of the first upstream hole and a straight line connecting an external diameter side exit end portion on the exit surface of the first upstream hole and an external diameter side exit end portion on the exit surface of the first downstream hole is 45 deg. or larger.

8. The fuel injection valve according to claim 1, wherein
in a state where the fuel injection valve is attached to an internal combustion engine, the first injection hole among the plurality of injection holes is disposed to be oriented most to a front end portion of an ignition plug.

9. The fuel injection valve according to claim 1, wherein
among the plurality of injection holes, a second injection hole positioned in an end portion on an opposite side of the first injection hole with respect to a valve element center axis includes a second upstream hole formed on an upstream side and a second downstream hole that is connected to the second upstream hole and formed on a downstream side of the second upstream hole, and
a center axis of the second downstream hole is configured to be eccentric to a center axis side of the fuel injection valve relative to a center axis of the second upstream hole.

10. A fuel injection valve comprising a plurality of injection holes on a front end section, each of the plurality of injection holes including an upstream hole formed on an upstream side and a downstream hole that is connected to the upstream hole and formed on a downstream side of the upstream hole, wherein
the first injection hole is configured so that an angle formed by a tangent drawn parallel to an exit surface of a first upstream hole and a straight line connecting an internal diameter side exit end portion on the exit surface of the first upstream hole and an internal diameter side exit end portion on an exit surface of the first downstream hole is smaller than an angle formed by a tangent drawn parallel to the exit surface of the first upstream hole and a straight line connecting an external diameter side exit end portion on the exit surface of the first upstream hole and an external diameter side exit end portion on the exit surface of the first downstream hole, and
a second injection hole positioned in an end portion on an opposite side of the first injection hole with respect to a valve element center axis among the plurality of injection holes is configured so that an angle formed by a tangent drawn parallel to an exit surface of a second upstream hole and a straight line connecting an internal diameter side exit end portion on the exit surface of the second upstream hole and an internal diameter side exit end portion on an exit surface of the second downstream hole is smaller than an angle formed by a tangent drawn parallel to the exit surface of the second upstream hole and a straight line connecting an external diameter side exit end portion on the exit surface of the second upstream hole and an external diameter side exit end portion on the exit surface of the second downstream hole.

11. A fuel injection valve comprising a plurality of injection holes on a front end section, each of the plurality of injection holes including an upstream hole formed on an upstream side and a downstream hole that is connected to the upstream hole and formed on a downstream side of the upstream hole, wherein
the first injection hole is configured so that an angle formed by a tangent drawn parallel to an exit surface of a first upstream hole and a straight line connecting an internal diameter side exit end portion on the exit surface of the first upstream hole and an internal diameter side exit end portion on an exit surface of the first downstream hole is smaller than an angle formed by a tangent drawn parallel to the exit surface of the first upstream hole and a straight line connecting an external diameter side exit end portion on the exit surface of the first upstream hole and an external diameter side exit end portion on the exit surface of the first downstream hole, and
a third injection hole formed adjacent to the first injection hole in a circumferential direction is configured so that an angle formed by a tangent drawn parallel to an exit surface of a third upstream hole and a straight line connecting an internal diameter side exit end portion on the exit surface of the third upstream hole and an internal diameter side exit end portion on an exit surface of the third downstream hole is larger than an angle formed by a tangent drawn parallel to the exit surface of the third upstream hole and a straight line connecting an external diameter side exit end portion on the exit surface of the third upstream hole and an external diameter side exit end portion on the exit surface of the third downstream hole.

12. The fuel injection valve according to claim 10, wherein
among the plurality of injection holes, a third injection hole formed adjacent to the first injection hole in a circumferential direction includes a third upstream hole formed on an upstream side and a third downstream hole that is connected to the third upstream hole and formed on a downstream side of the third upstream hole, and
an angle formed by a tangent drawn parallel to an exit surface of the third upstream hole and a straight line connecting an internal diameter side exit end portion on the exit surface of the third upstream hole and an internal diameter side exit end portion on an exit surface of the third downstream hole is larger than an angle formed by a tangent drawn parallel to the exit surface of the third upstream hole and a straight line connecting an external diameter side exit end portion on the exit surface of the third upstream hole and an external diameter side exit end portion on the exit surface of the third downstream hole.

13. The fuel injection valve according to claim 10, wherein
in a state where the fuel injection valve is attached to an internal combustion engine, the first injection hole among the plurality of injection holes is disposed to be oriented most to a front end portion of an ignition plug, and
the second injection hole is disposed to be oriented most to an upper surface center portion of a piston.

14. The fuel injection valve according to claim 10, wherein
among the plurality of injection holes, a third injection hole formed adjacent to the first injection hole in a circumferential direction includes a third upstream hole formed on an upstream side and a third downstream hole that is connected to the third upstream hole and formed on a downstream side of the third upstream hole, and
a center axis of the third downstream hole is at a position eccentric to a side away from a center axis of the fuel injection valve relative to a center axis of the third upstream hole.

15. The fuel injection valve according to claim 14, wherein
among the plurality of injection holes, a fourth injection hole formed adjacent to the third injection hole in a circumferential direction includes a fourth upstream hole formed on an upstream side and a fourth downstream hole that is connected to the fourth upstream hole and formed on a downstream side of the fourth upstream hole, and
a center axis of the fourth downstream hole is at a position eccentric to a side away from a center axis of the fuel injection valve relative to a center axis of the fourth upstream hole.

16. The fuel injection valve according to claim 5, wherein
among the injection holes, a third injection hole formed adjacent to the first injection hole in a circumferential direction includes a third upstream hole formed on an upstream side and a third downstream hole that is connected to the third upstream hole and formed on a downstream side of the third upstream hole, and
a center axis of the third downstream hole is at a position eccentric to a side away from a center axis side of the fuel injection valve relative to a center axis of the third upstream hole.
